(19) United States
(12) Patent Application Publication
(10) Pub. No.: US 2010/0216329 A1
(43) Pub. Date: Aug. 26, 2010

(54) Instrument cable lock

(76) Inventor: Isaac William Sabo, Bend, OR (US)

Correspondence Address: Isaac William Sabo, 19863 SW Quail Pine Loop, Bend, OR, 97702, US

(21) Appl. No.: 12/391,575

(22) Filed: Feb. 24, 2009

(51) Int. Cl. H01R 13/62

(52) U.S. Cl. 439/359

(57) ABSTRACT

In a preferred embodiment, this invention provides a simple, two-piece attachment that secures a power cable into an electric instrument (e.g., an electric guitar) in three steps. This invention ensures that the power cable from an amplifier stays securely inserted into a musical instrument such as a guitar, ensuring that the cable does not get pulled out of the instrument while it is being played.

### BACKGROUND OF THE INVENTION

1. Field of the Invention

The field of invention relates to electrical musical instruments; more specifically it relates to a device that locks an instrument's power cord to the instrument. Such cords are common and carry the signal from the musical instrument to the instrument's amplifier. An example is a cord that runs from an electric guitar to an amplifier.

2. Background Art

Many instruments have evolved from acoustic to electric models. An electrically powered amplifier is plugged into these instruments to amplify and emit the instrument's sound. The cord that connects amplifier to instrument has an end that is roughly 0.25 inches in diameter; this end plugs into a receptacle on the amplifier. The other end of this power cord (often referred to as a “quarter-inch plug”) is also roughly 0.25 inches in diameter. This plug fits into a receptacle on the body of the electric instrument and is held in place by a spring that provides a snap fit. The snap fit is configured so that the cord can be inserted and removed by hand without the need of tools. However any pull on the cord can result in the cord becoming accidentally disengaged from the instrument. Musicians who play electric instruments such as the electric guitar find that the instrument's power cord often does not remain securely placed in the guitar's cable socket, resulting in the cord being pulled out during a performance or during practice.

A device that secures the power cord from amplifier to instrument would ensure that the cable does not get pulled out of the instrument while it is being operated. A tool that provides this security in the form of an axially secured, threaded nut near the instrument-connection end would further hold the power cord securely into the musical instrument by offering a firmer, threaded-on method of engaging the power cord into the cable socket of the instrument. The device should be quick and easy to place, allowing the musician to concentrate on performance rather than equipment-preparation.

The following application and patents show devices and methods for locking power cords into devices such as an electric guitar:

U.S. Pat. No. 5,145,399 describes a cable lock apparatus for mounting a cable plug into a cable socket. It provides an apparatus that includes a mechanism that locks an electric cable (such as that used in electric guitars) between guitar and amplifier. In this apparatus, a mounting bracket includes a mounting plate pivotally mounting a support leg. The support leg mounts an abutment sleeve, wherein the abutment sleeve mounted to the support leg is positioned in abutment to a cable boss mounted to a cable plug of an associated cable. A modification of the invention includes a resilient bumper ring mounted coextensively and to a forward end of the abutment sleeve.

U.S. Pat. No. 6,198,031 describes a cord or cable lock for preventing a cord or cable from being accidentally pulled out of a socket of a musical instrument. The cable lock is in the form of a strip which is curled or curved at one end. Near the end distal from the curved portion, the cable lock has a hole which allows the cable lock to be mounted to a musical instrument using a screw. The curved portion of the cable lock surrounds the cable and frictionally grips the cable to keep tugs on the cable from being transmitted to a plug at the end of the cable, preventing the plug from being pulled out of the musical instrument's socket.

U.S. Pat. No. 5,582,524 describes a cord-securing device for maintaining two interconnected electrical plugs in a plugged-together electrical connection. The device includes eyelets secured to a base member. Each eyelet defines an opening sized to receive a looped portion of each electrical cord extending from the plugged-together ends. The looped portion of each cord is urged through one eyelet to engage a hook member secured to the base member. The hook members transfer the strain of connection of the electrical cords from the plugs to the cord-securing device.

U.S. Pat. No. 4,715,259 describes a strap-mounting assembly which mounts to the rear face of an electric guitar body at a balance point, permitting rotation of the guitar body about a horizontal axis at that balance point. The assembly includes a flat face plate with a tapped hole and a ring connector concentrically mounted about the tapped hole and insulated from the metal base plate. The flat base plate is screwed to the rear face of the guitar body with the ring connector facing out.

U.S. Pat. No. 3,951,504 describes a device for transferring the pull on an electrical cable to an anchor point includes a clamp having a cable engaging collar with a tapered bore engaged by a wedge whose advance clamps the cable. The collar is connected by a chain or plastic extension member to an annulus which is locked to an anchoring surface by being clamped between the male and female sections of a screw coupling associated with the cable, the extension member is shorter than the cable between the collar and anchoring point and the collar and wedge may be joined by an integrally formed flexible strap.

U.S. Pat. No. 4,357,063 describes a construction for protecting against damage to or unplugging of an electrical cord or plug connected to a portable musical instrument supported on the performer's shoulder by means of a strap attached to studs or the like projecting from the instrument body. The construction includes a washer removably mounted on one of such studs to prevent accidental dislodgement of the strap from the stud. It also serves as an anchoring point for the electrical cord.

U.S. Pat. No. 6,533,617 describes a plug connector for mating with a jack connector. The plug connector includes a base and a tubular member extending from the base. The tubular member includes a contact area, a conductive end distal to the base and a spring. The conductive end is insulated from the contact area and may have on it a circumferential groove.

A core may be disposed within the tubular member with an insulating material disposed about at least one signal conductor. An RCA-type plug connector includes an insulating ring having a central aperture and a probe member extending from the central aperture. The probe member has a spring portion and a terminal end and a conductive sleeve may be disposed about the insulating ring.

The present invention mitigates and/or obviates the disadvantages of the above inventions by offering a simple, two-piece attachment that secures a power cable into an electric instrument (e.g., an electric guitar) in three steps. This invention ensures, in a simple and direct application, that the power cable stays in the electric instrument during play.

A principal object of the present invention is to secure a power cord from an amplifier to a musical instrument (such as a guitar), ensuring that the cable does not get pulled out of the instrument while it is being played. Previous inventions, described above, involve many parts to achieve the same or similar result. In U.S. Pat. No. 5,145,399, for example, the high number of parts (approximately 16) necessitates complicated manufacture and assembly. The present invention involves only two parts. This makes it easy to manufacture, inexpensive to purchase, and simple to use.

### SUMMARY OF THE INVENTION

The present invention achieves the above objects, among others, by providing a simple, two-piece attachment that secures a power cable into an electric instrument (e.g., an electric guitar) in three steps. These and other objects, features and advantages of the present invention will become apparent by referring to the following description of preferred embodiments. The illustrations below are for example only. The figure numerals in parentheses refer to the figure in which the element(s) being described are more fully shown. The element(s) may also be shown on other figures.

### BRIEF DESCRIPTION OF THE DRAWINGS

FIG. 1A is a three-quarter perspective front view of the invention.

FIG. 1B is a three-quarter perspective rear view of the invention.

FIG. 2 is a section view of the invention.

FIG. 3 is an exploded view of the invention shown plugged into an electric guitar.

FIG. 4 is an exploded view of the invention's disassembled parts, unplugged from an electric guitar.

### DETAILED DESCRIPTION OF THE INVENTION

This invention 10 comprises two parts: a cylinder with a small distal end and a slightly larger proximal end, in addition to a connecting nut with an axial cut that envelops the cable and threads into the cylinder.

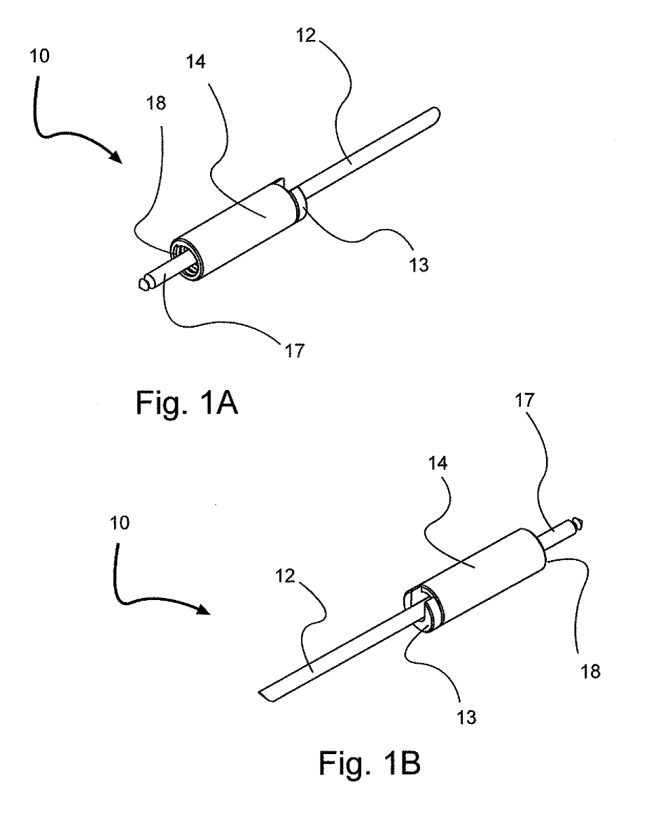

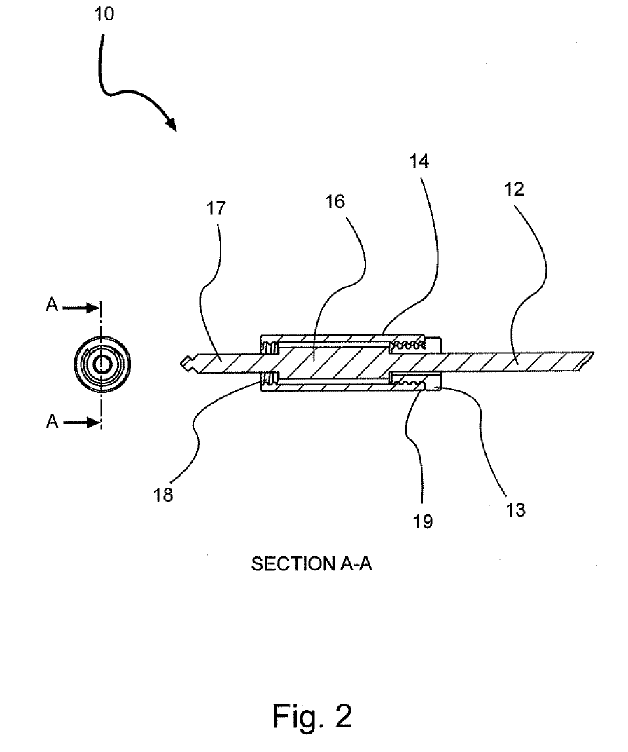

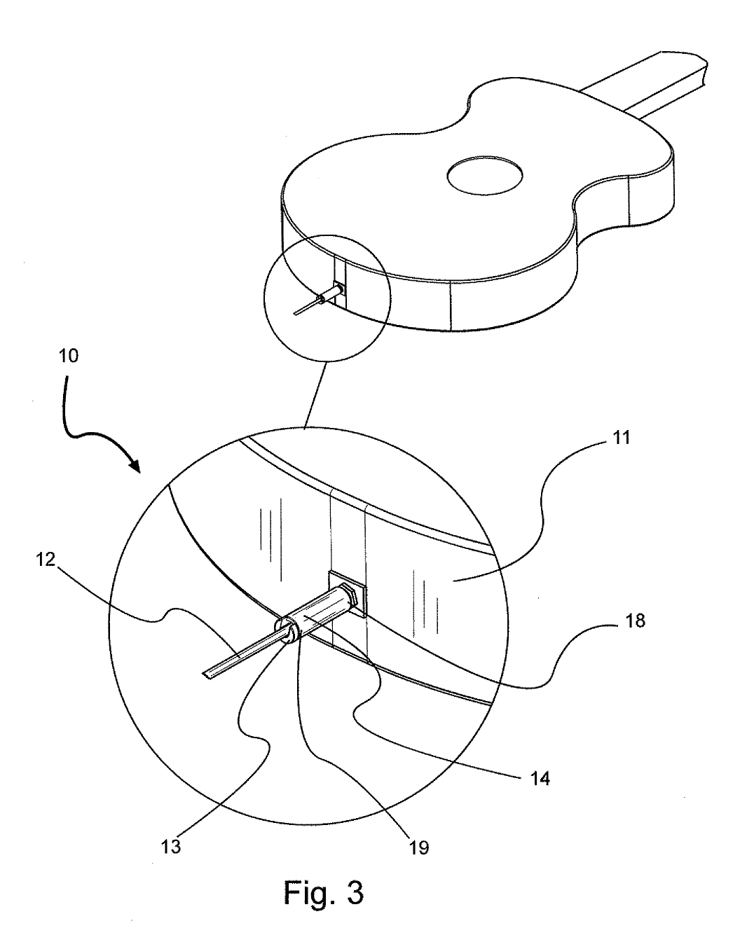

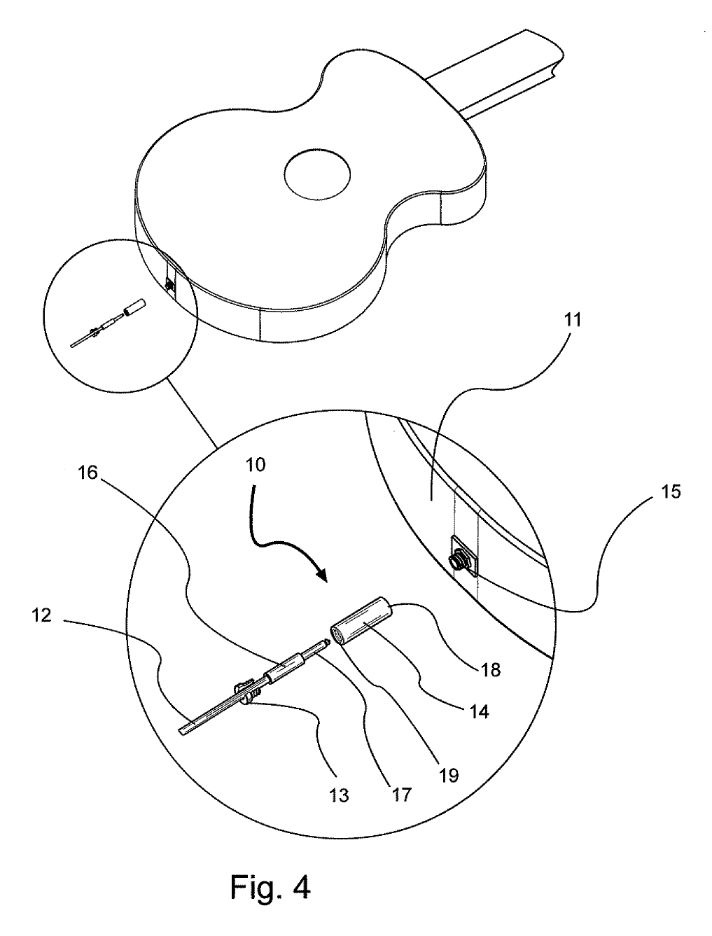

The cylinder's small, distal end 18 is threaded onto a common power cable socket 15 found on electric instruments such as electric guitars. A power cord 12 with a quarter-inch plug end 17 is passed through the cylinder 14 and plugged into the power cable socket 15 on the instrument body 11. The connecting nut with axial opening 13 is placed over the power cord 12 perpendicularly to the cord's central axis so as to envelope the cord (FIGS. 1A, 1B, 2, 3, 4). The connecting nut 13 is then moved parallel to the cord's central axis until it is engaged with the threads of the cylinder's proximal end 19. The nut is then threaded into the cylinder's proximal end 19, securing the power cable 12 inside the cylinder 14 and further securing the cylinder onto the instrument's cable socket 15 at the distal end 18. The connecting nut 13 is long enough and has enough threads to accommodate varying sizes of power cable sockets 15.

Since certain changes may be made in the above construction without departing from the scope of the invention, it is intended that everything contained in the above description or shown on the accompanying drawing figures shall be interpreted as illustrative only and not in a limiting sense.

1. A simple, two-piece attachment comprising: a cylinder with a small distal end and a slightly larger proximal end; and a connecting nut with an axial cut that envelops the cable and threads into the cylinder that secures a power cable into an electric instrument ensuring that the power cable remains securely inserted into the electric instrument during use.
